(19) United States
(12) Patent Application Publication
(10) Pub. No.: US 2015/0271615 A1
(43) Pub. Date: Sep. 24, 2015

(54) Acoustic Device and Acoustic Processing Method

(71) Applicant: YAMAHA CORPORATION, Shizuoka (JP)

(72) Inventors: Masaya Kano, Hamamatsu-shi (JP); Kenji Kawano, Hamamatsu-shi (JP); Susumu Kumazawa, Hamamatsu-shi (JP); Satoshi Yoshiizumi, Setagaya-ku (JP); Norimasa Hattori, Hamamatsu-shi (JP); Daigo Sugiura, Hamamatsu-shi (JP); Keishi Matsumoto, Hamamatsu-shi (JP)

(21) Appl. No.: 14/428,242

(22) PCT Filed: Nov. 8, 2013
(86) PCT No.: PCT/JP2013/080303

§ 371 Date: Mar. 13, 2015

(30) Foreign Application Priority Data
Nov. 8, 2012 (JP) 2012-246224

(51) Int. Cl. H04R 29/00; H04R 1/02

(52) U.S. Cl. CPC H04R 29/001; H04R 1/02

(57) ABSTRACT

An acoustic device includes a housing, a loudspeaker, a terminal provided for the housing, an identifying section that specifies an external unit mounted on the terminal, and a control section that determines a control content corresponding to the external unit identified by the identifying section and controls the loudspeaker according to the determined control content.

### TECHNICAL FIELD

This disclosure relates to an acoustic device and an acoustic processing method.

### BACKGROUND ART

A notebook PC is known wherein a mechanism is provided by which one of two types of detachable loudspeaker units is selectively mounted and audio output characteristics are changed automatically according to the acoustic characteristics of the mounted loudspeaker unit (refer to Patent Document 1).

### PRIOR ART DOCUMENT

### Patent Document

Patent Document 1: JP-A-2008-85902

### GENERAL DESCRIPTION OF THE INVENTION

### Problem that the Invention is to Solve

The technology described in Patent Document 1 is used in a notebook PC having a built-in loudspeaker and provided with two signal processing circuits that can be used selectively to control an external loudspeaker, wherein either one of the circuits is made valid depending on the type of the external loudspeaker mounted thereon. According to the technology described in Patent Document 1, in order that the sound suited for the characteristics (frequency band characteristics) of an external loudspeaker can be emitted, control for the external loudspeaker is performed.

On the other hand, control for the built-in loudspeaker is performed independently regardless of whether an external loudspeaker is mounted or regardless of the type of a mounted external loudspeaker. In other words, in the case that an external loudspeaker is mounted, a musical sound is emitted from the built-in loudspeaker as usual, and the musical sound is also emitted from the external loudspeaker. As a result, the volume level of the reproduced sound changes before and after the mounting. When it is assumed that the volume has been set appropriately for the musical sound reproduction performed by only the built-in loudspeaker, the user may feel an unexpected change in volume or the user takes time and effort to reset the volume appropriately; this is undesirable. This change in volume occurs similarly even in the case that volume setting has been performed on the assumption that an external loudspeaker is mounted.

As described above, in the conventional technology, the internal function provided beforehand for an acoustic device and the external function provided by an acoustic device, such as an external loudspeaker, connected to the acoustic device cannot be controlled integrally.

This disclosure is intended so that the connection and disconnection of an external unit is reflected to the control for the internal function of an acoustic device, whereby the connected external unit and the internal function are controlled integrally.

### Means for Solving the Problem

This disclosure provides an acoustic device including: a housing; a loudspeaker; a terminal provided on the housing; an identifying section that specifies an external unit mounted on the terminal; and a control section that determines a control content corresponding to the external unit identified by the identifying section and controls the loudspeaker according to the determined control content.

According to this disclosure, the connection and disconnection of an external unit is reflected to the control for the internal function of an acoustic device, whereby the connected external unit and the internal function can be controlled integrally.

### BRIEF DESCRIPTION OF THE DRAWINGS

FIG. 1(a) is a front view illustrating an external appearance of an acoustic device 100, and FIG. 1(b) is a side view illustrating the external appearance of the acoustic device 100;

FIG. 2(a) is a detailed view illustrating an external appearance of a connection section to which no external unit is connected, and FIG. 2(b) is a detailed view illustrating an external appearance of the connection section to which a loudspeaker unit 200 serving as an external unit is connected;

FIG. 3 is a view illustrating an external appearance of the acoustic device on which the loudspeaker unit 200 is mounted;

FIG. 4 is a view illustrating the function of the acoustic device 100;

FIG. 5 shows examples of contents to be stored in a device information database DB1;

FIGS. 6A-6D are views illustrating examples of information to be written in a control information table DB2;

FIG. 7 is a view illustrating a method for determining a sound pressure level;

FIG. 8 is a view illustrating the function of the loudspeaker unit 200;

FIG. 9 is a view illustrating the detailed structures of a connection section 110 and a connection section 250;

FIG. 10A is a view illustrating examples of contents to be stored in a table DB3, and FIG. 10B is a view illustrating examples of received data D1;

FIG. 11 is a view illustrating the function of a display unit 300;

FIG. 12 is a view illustrating an external appearance of the acoustic device 100 on which the display unit 300 is mounted;

FIG. 13 is a view illustrating the function of an operation knob 400;

FIG. 14 is a view illustrating an external appearance of the acoustic device 100 on which the operation knob 400 is mounted;

FIGS. 15A-15B are views illustrating other examples of the connection section 250, and FIG. 15C is a view illustrating another example of the connection section 110;

FIG. 16 is a view illustrating an operation example of the acoustic device 100;

FIG. 17 is a view illustrating the function of an LED light 500;

FIG. 18 is a view illustrating an external appearance of the acoustic device 100 on which the LED light 500 is mounted;

FIG. 19 is a view illustrating the function of an alarm function clock 600;

FIG. 20 is a view illustrating an external appearance of the acoustic device 100 on which the alarm function clock 600 is mounted; and

FIGS. 21A AND 21B are views illustrating an external appearance of the acoustic device 100 on which the loudspeaker unit 200 and a diffuser 700 are mounted.

### MODE FOR CARRYING OUT THE INVENTION

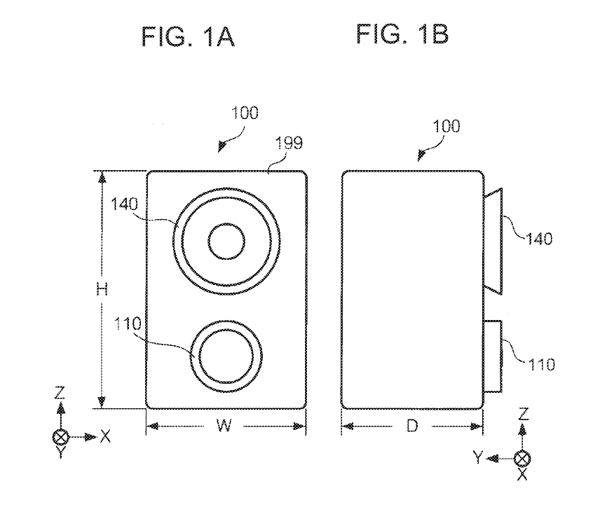

FIGS. 1(a) and 1(b) are front and side views illustrating an external appearance of an acoustic device 100. The acoustic device 100 is an acoustic device having a function as a general acoustic loudspeaker. The acoustic device 100 has a housing 199, a loudspeaker unit 140 and a connection section 110. The housing 199 has a nearly rectangular parallelepiped shape, and the width (in the X direction), the depth (in the Y direction) and the height (in the Z direction) thereof are represented by W, D and H, respectively, in FIGS. 1(a) and 1(b). The loudspeaker unit 140 is fixed to the housing 199. The connection section 110 is provided on the front face of the housing 199. In addition, the acoustic device 100 has power source and musical sound input/output terminals, but these are not illustrated.

The loudspeaker unit 140 is a loudspeaker unit composed of a voice coil, a vibration body, such as a cone, etc. (these are not illustrated), and emits an acoustic wave in the front direction (in the −Y direction) according to an input acoustic signal. The housing 199 functions as a member for accommodating a power source, various control circuits, etc. inside and has a function as the enclosure of the loudspeaker unit. The connection section 110 is a structure provided for the connection to an external unit.

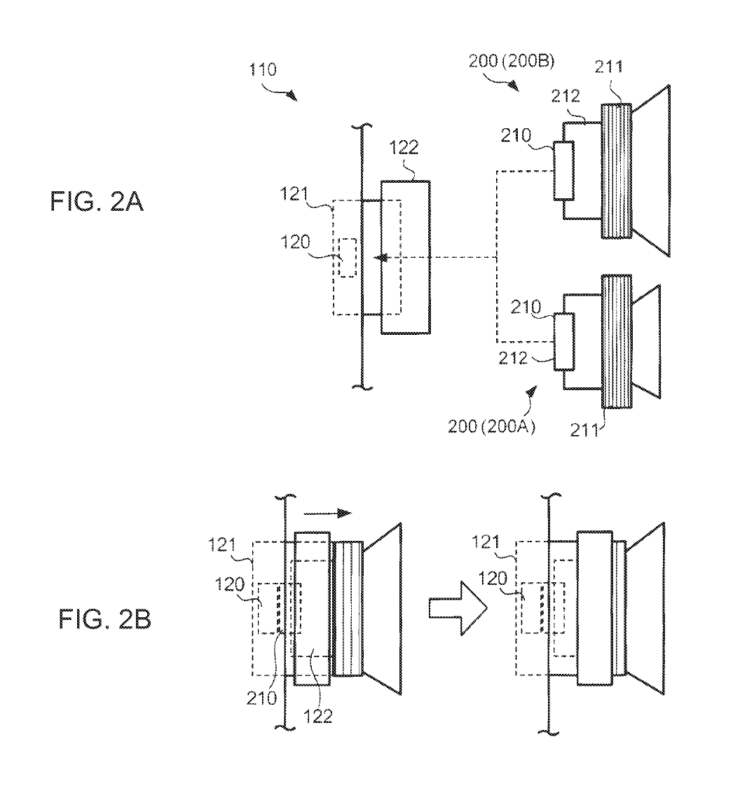

FIG. 2(a) is a mechanically detailed view illustrating the connection section 110 to which no external unit is connected, and FIG. 2(b) is a mechanically detailed view illustrating the connection section 110 to which a loudspeaker unit 200 serving as an external unit is connected.

As illustrated in FIG. 2(a), the connection section 110 includes a is terminal 120, a guide 121 and a nut cover 122. The terminal 120 is a terminal having a predetermined pin arrangement and is used to electrically connect the acoustic device 100 to an external unit in an embodiment. The guide 121 and the nut cover 122 are used to provide a mechanism for physically fixing the external unit to the acoustic device 100. The guide 121 has a cylindrical hollow shape, on the outside of which a screw groove is formed, thereby serving as a structure for guiding the insertion of the external unit. The position of the terminal 120 on the side of the acoustic device 100 is aligned with the position of the terminal on the side of the external unit by the guide 121. The nut cover 122 is a ring-shaped member and a screw groove is formed on the inside. The external unit is fixed to the acoustic device 100 by tightening the nut cover 122.

The acoustic device 100 is configured so that one of a plurality of types of external units having a predetermined mounting mechanism can be selectively mounted thereon. FIG. 2(a) shows that a loudspeaker unit 200A and a loudspeaker unit 200B, being different from each other, can be mounted.

The mounting mechanism will be described by taking the loudspeaker unit 200 as an example. The loudspeaker unit 200 is composed of a main body section 212, a terminal 210 and a screw 211. The terminal 210 is used to exchange electrical signals with the acoustic device 100 by making contact with the terminal 120. The screw 211 is a ring-shaped member provided on the outside of the main body section 212, and a screw groove is formed on the outside. The main body section 212 is the main body section of the loudspeaker unit including a vibration generator, such as a voice coil, and a vibration body, such as a cone (these are not illustrated). The main body section 212 may further include a diffuser, an acoustic panel, etc. for changing the characteristics of the acoustic wave emitted therefrom.

FIG. 2(b) is a view illustrating a state in which the external unit is mounted on the acoustic device 100. First, as illustrated on the left side of FIG. 2(b), the external unit is inserted into the guide 121, and then the nut cover 122 is rotated to tighten the screw 211 of the external unit. As a result, the external unit is fixed to the acoustic device 100 while their terminals are made contact with each other.

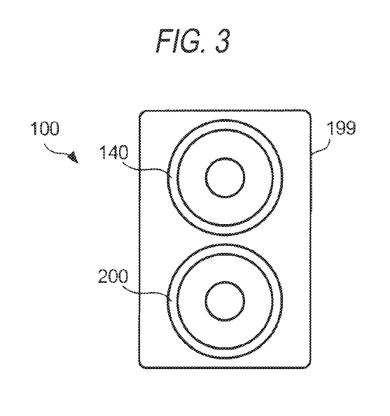

When the loudspeaker unit 200 is mounted on the acoustic device 100, the external appearance thereof is as illustrated in FIG. 3. Although both the loudspeaker units 140 and 200 are one-way loudspeakers in the examples illustrated in FIGS. 1 to 3, they may be two or more way loudspeakers. This applies to the following examples.

All the external units are characterized, with respect to the physical shape thereof, so as to be provided with a terminal having a shape corresponding to the shape of the terminal 120, a main body section having a shape matching with the shape of the guide 121, and the screw 211 having a shape corresponding to the shape of the nut cover 122. With this structural characteristic, the external units are physically connectable to the acoustic device 100. The above-mentioned physical mechanism for connecting the external unit to the acoustic device 100 is taken as an example and any mechanisms may be adopted.

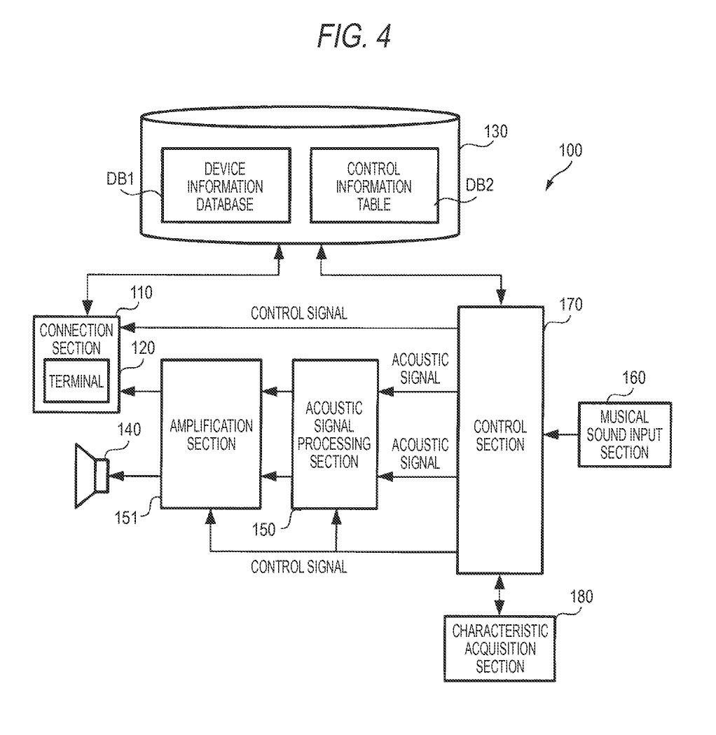

FIG. 4 is a view illustrating the function of the acoustic device 100. The acoustic device 100 includes the connection section 110, a storage section 130, the loudspeaker unit 140, an acoustic signal processing section 150, an amplification section 151, a musical sound input section 160, a control section 170, and a characteristic acquisition section 180.

The storage section 130 is a recording medium, such as a ROM, an HDD or a semiconductor memory device, in which a device information database DB1 and a control information table DB2 are stored.

FIG. 5 shows examples of the contents of the device information database DB1. In association with the identification code of each external unit that is connectable to the acoustic device, unit type and input/output information are written in the device information database DB1. In a preferable embodiment, function information is stored additionally depending on the unit type. The control section 170 retrieves the inside of the device information database DB1 by using the identification code as a key, thereby acquiring the input/output information and the functional characteristics of the unit identified by the identification code. Furthermore, in the case that the control section 170 has newly acquired an identification code together with the input/output information and the functional information corresponding thereto as a set, the control section 170 adds the information to the records of the device information database DB1. In the case that the functional characteristics corresponding to the identification code have been acquired afterward, the characteristics may be added to the device information database DB1.

One identification code is assigned to one external unit, whereby each external unit is identified uniquely. In the example illustrated in FIG. 5, for example, the three higher order digits indicate the type of the unit, and the four lower order digits indicates the model number of the unit. The unit type indicates the type of the unit and the functional classification thereof.

The input/output information is information on what kind of function the external unit has; in other words, the information indicates the outline of the function of the external unit. More specifically, in the case that the external unit is connected, information on what kind of control information the acoustic device 100 receives (“IN”) from the external unit or information on what kind of signal the acoustic device 100 should supply (“OUT”) to the external unit (or the acoustic device 100 does not supply anything) is described.

The functional characteristics are described as information on what kind of characteristics the unit has. For example, in the case of a loudspeaker, the characteristics include information on the characteristics of the loudspeaker, such as the reproducible frequency band, the maximum allowable input, the directivity, the number of multi-ways, the material and size of the vibration body, etc. of the loudspeaker.

For example, the external unit identified by the identification code “001-01123” in FIG. 5 is a type of a device characterized in that there is no signal to be supplied to the acoustic device 100 and that the signal to be supplied from the acoustic device 100 to the external unit is an acoustic signal. On the other hand, the external unit identified by the identification code “003” is a type of a device characterized in that the signal to be supplied from the external unit is information that designates the overall volume level of the acoustic device 100 and that there is no signal to be supplied to the external unit. This type of the device corresponds to an input device or an acoustic device having a function for designating various kinds of parameters relating to the reproduction of a musical sound, such as an operation knob and others. An external unit having information described with respect to both IN and OUT (i.e., a device that supplies a signal to the acoustic device and operates on the basis of a signal from the acoustic device 100) may also be registered in the device information database DB1 as a matter of course.

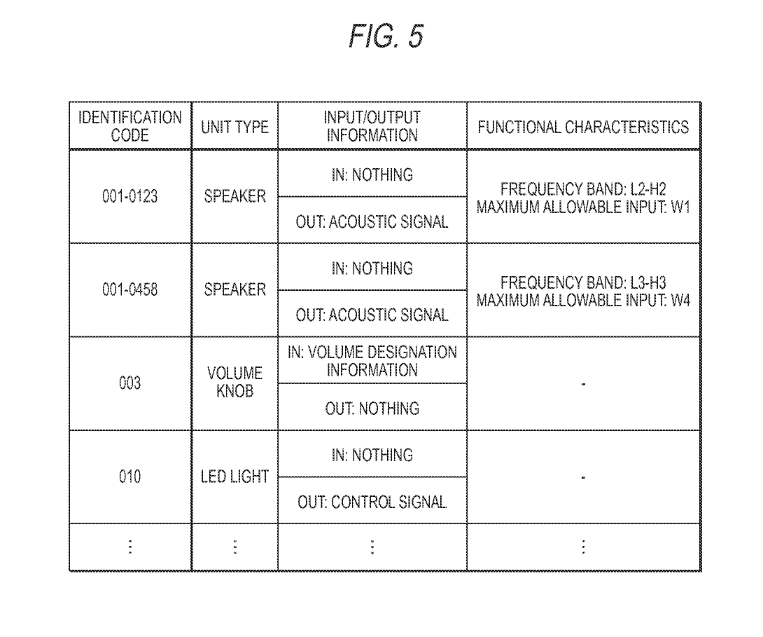

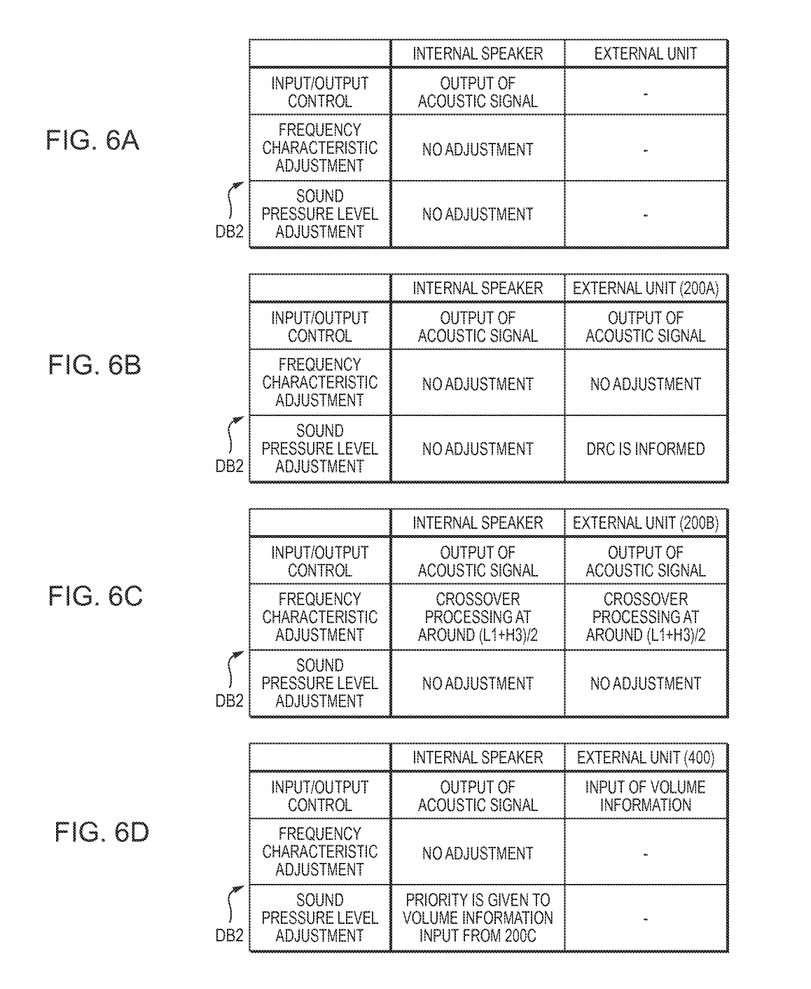

The control information for controlling the loudspeaker unit and the control information for controlling the external unit generated on the basis of the contents of the device information database DB1 are written in the control information table DB2. FIGS. 6(a) to 6(d) show examples of the contents of the control information table DB2. The control information table DB2 represents information on what kind of control is performed for the loudspeaker unit 140 and the external unit, and the contents thereof are maintained unless a new unit is detected later. On the basis of the contents of the control information table DB2, the control section 170 generates a signal for controlling at least either the acoustic signal processing section 150 or the amplification section 151.

FIG. 6(a) shows examples of the contents to be stored in the control information table DB2 in the case that no external unit is connected; FIG. 6(b) shows examples of the contents to be stored therein in the case that the loudspeaker unit 200A is connected; FIG. 6(c) shows examples of the contents to be stored therein in the case that the loudspeaker unit 200B is connected; and FIG. 6(d) shows examples of the contents to be stored therein in the case that an operation knob 400 is connected. As illustrated in FIGS. 6(a) and 6(b), the control information includes control information for at least the internal loudspeaker; and in the case that an external unit having been connected is existent, the control information further includes control information for the external unit. As the control items of the control information, “input/output control”, “frequency characteristic adjustment” and “sound pressure level adjustment” are existent.

Information specifying what kind of data is supplied to the external unit 140 (and an external unit in the case that the external unit is connected) is described in the item “input/output control”. In the example illustrated in FIG. 6(a), the information item specifies that the acoustic signal having been input through the musical sound input section 160 should be supplied only to the is loudspeaker unit 140. In the example illustrated in FIG. 6(b), the information item designates that the acoustic signal is output to the loudspeaker unit 140 and the loudspeaker unit 200A serving as an external unit. In the example illustrated in FIG. 6(d), the information item represents that the acoustic device 100 outputs no signal to the operation knob 400 serving as an external unit but that volume information serving as a control signal is supplied from the operation knob 400 to the acoustic device 100.

Parameters for designating the frequency characteristics of the sound to be emitted from the loudspeaker unit 140 and the loudspeaker unit 200 are stored in the item “frequency characteristic adjustment”. In the example illustrated in FIG. 6(c), the information item describes that frequency crossover processing is performed, and also describes a frequency band to be subjected to the processing as the contents of the crossover processing. The crossover processing is performed to process an acoustic signal to lower its volume level beforehand in a predetermined frequency band in order to avoid trouble in which in the case that a plurality of loudspeakers respectively have different reproducible frequency bands, when an acoustic signal is directly input to the plurality of loudspeakers without being processed, the qualities of the sounds to be reproduced are deteriorated, for example, sounds in frequency ranges having a common reproducible frequency band are unnaturally emphasized.

As an example of this signal processing, as illustrated in FIG. 6(c), in the case that the reproducible band of the loudspeaker unit 140 ranges from L1 to H1 and that the reproducible band of the loudspeaker unit 200 ranges from L2 to H2 (L1<L2<H1<H2), processing is conceived in which the output level is lowered according to a predetermined algorithm in the band with a frequency width A (constant value) centered at a frequency (L2+H1)/2.

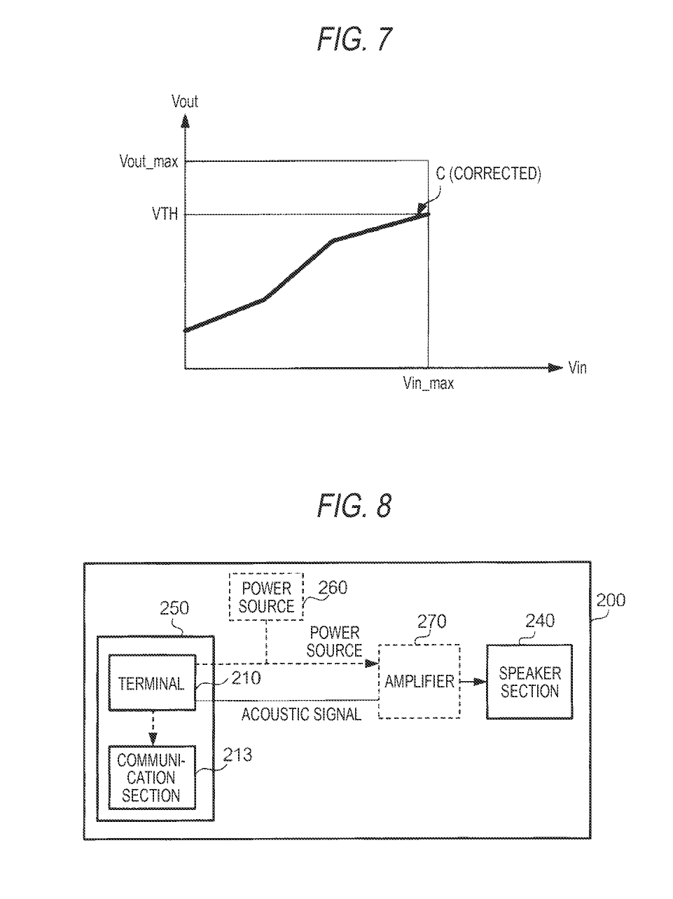

A determination as to whether the level of an input acoustic signal is corrected and the specific content of the correction is described in the item “sound pressure level adjustment”. For example, in the example illustrated in FIG. 6(b), the item describes that dynamic range compression (DRC) is performed only for the loudspeaker unit 200. DRC is a process for compressing the range (dynamic range) from the lower limit to the upper limit of an input signal level by raising the lower limit and by lowering the upper limit. More specifically, as illustrated in FIG. 7, for example, in the external loudspeaker unit 200, in the case that the maximum allowable input of the loudspeaker is W1 and is lower than the output capacity of the power amplifier of the main body, when it is assumed that the level corresponding to the maximum allowable input is Vth, output control is performed so that Vout is lower than Vth (refer to the input/output characteristic curve S (Corrected)).

A situation in which a large sound exceeding the allowable input level is input and the loudspeaker is damaged is prevented by performing the above-mentioned control. In addition, in the example illustrated in FIG. 7, the level of the signal in which Vout is in a small volume range is raised. This control is performed with the consideration that a loudspeaker not satisfying the sound output specifications of the main body may be inferior in the reproduction capacity of the s all volume range. However, the process for this small volume range may be omitted. In other words, in this embodiment, a level suppressing process for at least the large volume range may merely be performed.

The information described in the control information table DB2 is referred to by the control section 170 when a signal to be supplied to the acoustic signal processing section 150 (and the external unit as necessary) is generated. The control information to be stored in the control information table DB2 is generated each time the connection of an external unit is detected, and the information is effective until the connection section 110 detects the disconnection of the external unit. In other words, the contents of the control information table DB2 are rewritten each time the external unit is connected and disconnected. While no external unit is connected, the control information (see FIG. 6(a)) for the preset loudspeaker unit is effective.

Returning to FIG. 4, the musical sound input section 160 is realized by a communication control circuit, an input terminal, a cable (not illustrated), etc., acquires an acoustic signal (waveform data and other information according to which a sound is generated using the loudspeaker unit 140) and supplies the acoustic signal to the control section 170. For example, the acoustic signal is supplied from a digital audio player that is wirelessly connected (for example, connected via Bluetooth (trademark)) or connected via Line to the acoustic device 100. Alternatively, in the case that an acoustic signal has been stored in the storage section 130, the musical sound input section 160 may serve as a memory access controller and may have a function of reading the acoustic signal from the storage section 130 and supplying the signal to the control section 170. Further alternatively, the musical sound input section 160 may be equipped with a network interface and may have a function of downloading musical sound data from a server via a network.

The acoustic signal processing section 150 is realized by an analog/digital converter, a digital/analog converter, an acoustic signal processing filter and other signal processing circuits and signal processing processors, performs signal processing according to the acoustic signal and control signal supplied from the control section 170, and outputs the processed signal to the amplification section 151. The amplification section 151 has a signal amplification circuit, etc., amplifies the signal output from the acoustic signal processing section 150 according to the amplification factor designated by the control section 170, and supplies the amplified signal to the loudspeaker unit 140. As a result, the vibration corresponding to the input signal is generated by the loudspeaker unit 140, and the vibration is propagated as an acoustic wave in the air and reaches the ears of the user,

The characteristic acquisition section 180 serving as a communication interface accesses an external device via a communication network as necessary and acquires information for controlling an external unit or the acoustic device 100. The external device includes, for example, a device having information that can relate to the control of the acoustic device 100, such as a server in which information relating to the external unit is stored, a server in which information relating to the control of the acoustic device 100 is stored and a device for transmitting a musical sound signal to the acoustic device 100.

The connection section 110 supplies the identification code of an external unit to be connected thereto via the terminal 120 to the control section 170.

The control section 170 is realized by a processor. Upon receiving an identification code from the connection section 110, the control section 170 refers to the device information database DB1 and extracts information relating to the external unit having been registered in association with the received identification code. The control section 170 then generates control information for controlling at least either the acoustic signal processing section 150 or the amplification section 151 on the basis of the extracted information and writes the generated information in the control information table DB2. The control information includes, for example, information for designating which of one or more filters of the acoustic signal processing section 150 is validated or invalidated, information for specifying the operation of the circuit of the amplification section 151, information for designating control signal supplying timing, and information affecting the characteristics of the acoustic wave to be emitted from the loudspeaker unit. In other words, the control section 170 determines the control contents corresponding to the external unit identified by the connection section 110 and controls, according to the determined control contents, at least either the acoustic signal processing section 150 or the amplification section 151 that is used to output a signal to the loudspeaker.

Furthermore, on the basis of the information stored in the device information database DB1, the control section 170 determines whether it is necessary to output a signal to the connected external unit, and in the case that the output is necessary, the control section 170 generates information to be output to the external unit using a predetermined control algorithm. This information includes an acoustic signal in the case that the external unit is, for example, an acoustic device, such as the loudspeaker unit 200. Alternatively, in the case that the external unit is not a device directly relating to acoustics, the information may include control information for controlling the device. The information generated as described above is written in the control information table DB2.

The control section 170 refers to the control information table DB2 as necessary and outputs the signal input from the musical sound input section 160 or a control signal to the external unit via the terminal 120. Hence, the operation of the external unit can be controlled by the control section 170.

FIG. 8 is a view illustrating the functional configuration of the loudspeaker unit 200 serving as an external unit. The loudspeaker unit 200 includes a loudspeaker section 240, a connection section 250, an amplification section 270 and a power source 260. The components indicated in broken lines in FIG. 8 are not essential. This applies similarly to the following examples. The loudspeaker section 240 is composed of a voice coil and a vibration cone and generates an acoustic wave on the basis of an input acoustic signal. The connection section 250 has the terminal 210 to be connected to the acoustic device 100, receives an acoustic signal (or in addition to this, power source), and supplies the acoustic signal to the loudspeaker section 240 in the end. The amplification section 270 has a signal amplification circuit, etc., amplifies the signal input thereto according to the amplification factor designated by the control signal supplied from the acoustic device 100, and outputs the amplified signal to the loudspeaker section 240. A communication section 213 has a processor, a communication interface and a memory, and transmits, to the acoustic device 100 that is connected via the connection section 110, an identification code (and in addition to this, the functional characteristics of the corresponding external unit (in this case, the loudspeaker unit 200)) stored in the memory and used to identify the loudspeaker unit 200. Information relating to the control of the acoustic device 100 may be stores in the memory and may be provided for the acoustic device 100. With this configuration, the control programs for the acoustic device can be updated by connecting the external unit.

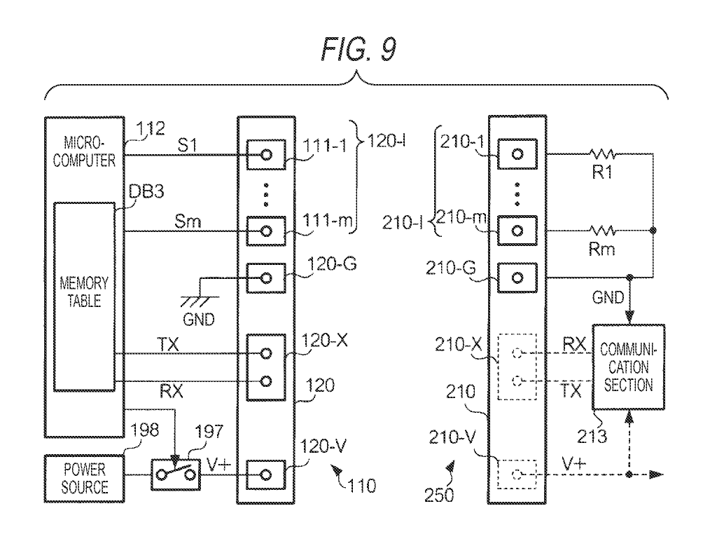

The structures and methods for the connection and information exchange between the acoustic device 100 and the loudspeaker unit 200 via is the connection sections 110 and 250 will be described below in detail referring to FIG. 9.

First, the structure on the side of the acoustic device 100 will be described. The connection section 110 includes a microcomputer 112, the terminal 120, a power source 198, and a switch 197. The terminal 120 is roughly divided into terminals 120-I, 120-G, 120-X and 120-V. The terminal 120-I totally includes m ports, i.e., ports 111-1 to 111-m. The respective ports are connected to the potential V+ of the power source via signal lines S1 to Sm and via pull-up resistors (not illustrated) inside the microcomputer.

The terminal 120-G is a terminal connected to the ground. The terminal 120-X is composed of a transmission terminal (TX) and a reception terminal (RX) and communicates with the communication section 213 of the loudspeaker unit 200 and receives the identification code of the loudspeaker unit 200 from the loudspeaker unit 200. The terminal 120-V is connected to the power source line and is used to supply the power source. The switch 197 is controlled by the microcomputer 112; when the switch is ON, the terminal 120-V is connected to the potential V+ of the power source, and the power source is supplied to the external unit connected to the terminal 120-V. When the switch is OFF, the power source is not supplied to the external unit.

Next, the structure of the connection section on the side of the external unit will be described by taking the loudspeaker unit 200 as an example. The connection section 250 constituting the loudspeaker unit 200 is composed of is the terminal 210 and the communication section 213 as illustrated in FIG. 8. In other words, the external unit is roughly classified into a unit with the communication section 213 and a unit without it. The terminal 210 is roughly divided into terminals 210-I, 210-G, 210-X and 210-V.

The terminal 210-I totally includes m ports, i.e., ports 210-1 to 210-m, at maximum, and connected to the loudspeaker unit (external loudspeaker) 200. Identification resistors R1 to Rm are connected to the respective ports. The respective ports are connected to the corresponding ports on the side of the acoustic device 100.

The terminal 210-G is connected to the terminal 120-G. The terminal 210-X is a terminal to be connected to the terminal 120-X and is used to exchange the identification code between the communication section 213 and the microcomputer 112 in response to a request signal or a request. The terminal 210-V is a terminal to be connected to the terminal 120-V. The power source supplied from the side of the acoustic device 100 is supplied to the communication section 213 and is also supplied to the amplification section 270 as necessary.

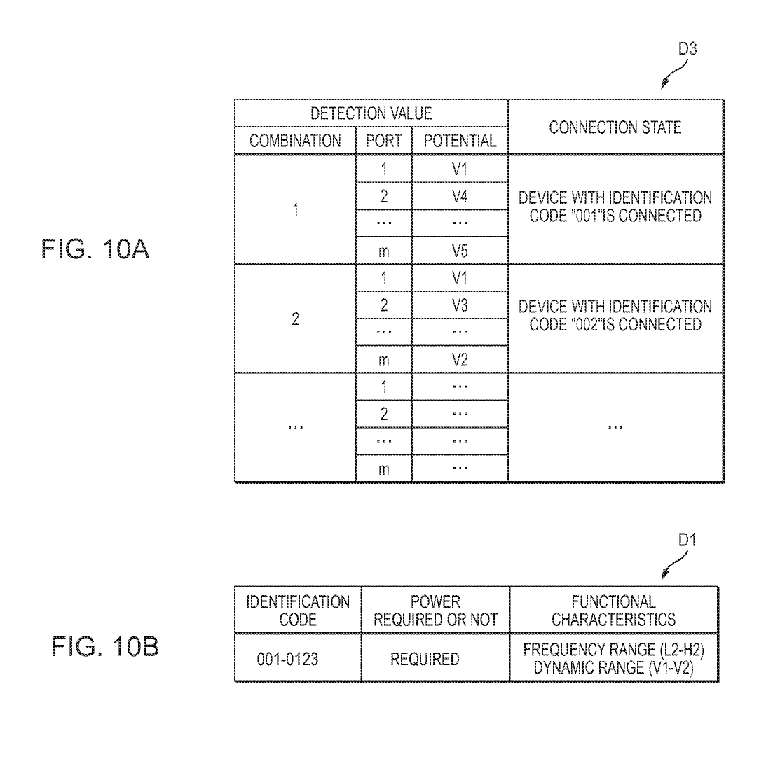

When the terminal 120 is made contact with the terminal 210 by the connection between the external unit to the acoustic device performed by the user, resistor circuits are formed by the identification resistors R1 to Rrn and the pull-up resistors inside the microcomputer between the connection section 110 and the connection section 250. At this time, the potential at each port, being dependent on the value of the identification resistor, is detected by the computer (microcomputer) 112. The microcomputer 112 specifies the connection state of each port on the basis of the detected potential. More specifically, as illustrated in FIG. 10(a), a table DB3, in which the combination of respective ports and the potentials at the ports is associated with the connection state (the identification code of the device connected as an external unit) and stored, is prepared beforehand, and the identification code corresponding to the potentials is identified by referring to this table.

In a preferred embodiment, the microcomputer 112 may specify information on the functional characteristics of the device on the basis of the detected potentials in addition to the identification code. Furthermore, some of the ports 111-1 to 111-m may be used for device identification, and the other ports may be used to transmit information (for example, the characteristics of the external unit and the control signals for the acoustic device) from the external unit to the acoustic device 100 or may be used transmit information (for example, control information) from the acoustic device 100 to the external unit.

When the external unit is identified and the functional characteristics of the external unit are acquired by the connection section 110 as described above, the acquired information is supplied to the control section 170.

In addition to the above-mentioned method for identifying a connection partner on the basis of the potentials, in the case that the external unit has the communication section 213, the microcomputer 112 has a function for is identifying a device (or in addition to this, a function for acquiring information on the characteristics of the device) by acquiring the identification code supplied from the communication section 213.

For example, in the above-mentioned table DB3, a voltage value or a condition for the voltage value at a predetermined one of the ports (for example, 111-n; n<m) is set. Then, in the case that the potential detected at this port satisfies this condition, the microcomputer 112 judges the type of the external unit or determines the characteristics thereof on the basis of the information received from the loudspeaker unit 200 via the terminal 120-V without adopting the information (the type of the external unit and the characteristics thereof) identified according to the table DB3. In this case, this information includes at least the above-mentioned identification code (for example, “001”).

As described above, with this embodiment, the microcomputer 112 can identify a device and acquires the functional characteristics thereof in accordance with the state of physical contact even if the external unit has not a function (the communication section 213) for transmitting the identification code and the functional characteristics. For example, even if the external unit has no information transmitting/receiving function, if the external unit has the connection section 250 and predetermined information has been registered on the side of the acoustic device 100 beforehand, the external unit is recognized by the acoustic device 100, and the external unit can be integrally operated with the acoustic device 100 in accordance with the state of the external unit. On is the other hand, in the case that the external unit has the function for transmitting the identification code and the functional characteristics, the external unit can provide, to the side of the acoustic device 100 the amount of information on the characteristics of the external unit exceeding physical limitation in the number of ports. The above-mentioned integrated operation can be achieved by transmitting the functional characteristics together with the identification code as described above even if the functional characteristics have not been registered beforehand in the acoustic device 100.

In a preferred embodiment, the microcomputer 112 performs the ON/OFF switching of the switch 197 on the basis of the above-mentioned contact state and the information received from the communication section 213. More specifically, in the case that the potential detected at a predetermined one of the ports 111-1 to 111-m indicates a predetermined voltage value (or a range of voltage values), the microcomputer 112 turns ON the switch 197 and supplies power to the loudspeaker unit 200. Alternatively, in the case that predetermined flag information is included in the information transmitted from the communication section 213, the microcomputer 112 turns ON the switch 197. This information is generated, for example, as data D1 having a data format including an identification code (7-digit), a power source necessity/non-necessity indication flag (1 bit) and a functional information area provided with a predetermined number of bits as illustrated in FIG. 10(b), and the information is transmitted and received. Since the power source necessity/non-necessity information is exchanged, power can be supplied from the acoustic device only in the case that the loudspeaker unit 200 requires power.

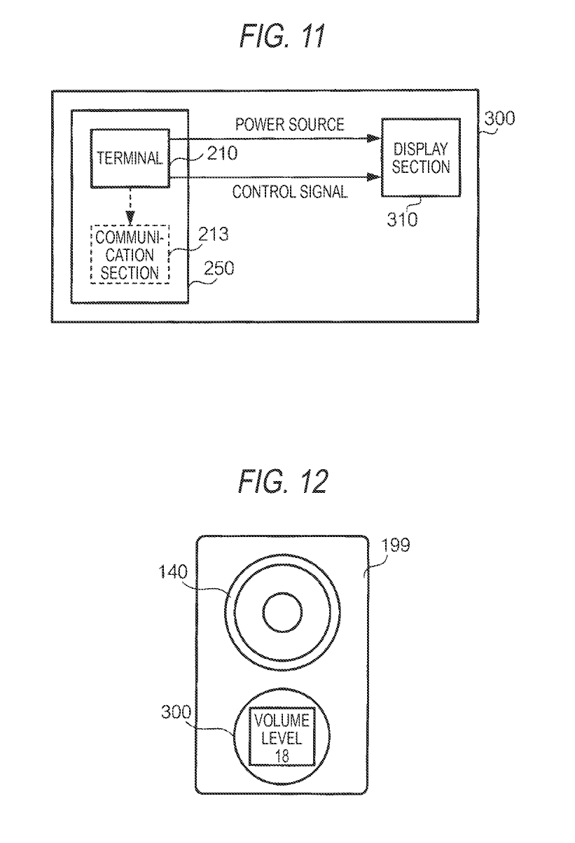

A device other than that operates on the basis of control signals from the acoustic device 100 may also be connected to the acoustic device 100. FIG. 11 is a view illustrating the function of a display unit 300 serving as an example of an external unit to be connected to the acoustic device 100, other than the loudspeaker unit 200. The display unit 300 includes a display section 310 and the connection section 250. The display section 310 is a display device composed of a liquid crystal panel and a circuit for driving the panel and controls display on the basis of the control signals supplied from the acoustic device 100 via the connection section 250. In a preferred embodiment, the control signals include information indicating the sound pressure level (volume) of the sound emitted from the loudspeaker unit 140, and the user can confirm the volume having been set in the acoustic device 100 at present by virtue of the display unit 300.

FIG. 12 is a front view illustrating the acoustic device 100 in the case that the display unit 300 is mounted thereon. This information is generated on the basis of the amplification factor supplied from the control section 170 to the amplification section 151. The control signals to be received by the display unit 300 may include information relating to the processing being performed inside the acoustic device 100 in addition to the volume. The method for displaying the information may be implemented in an analog or digital manner, and the contents to be displayed may be those relating to any acoustic characteristics, such as frequency characteristics, in addition to the volume.

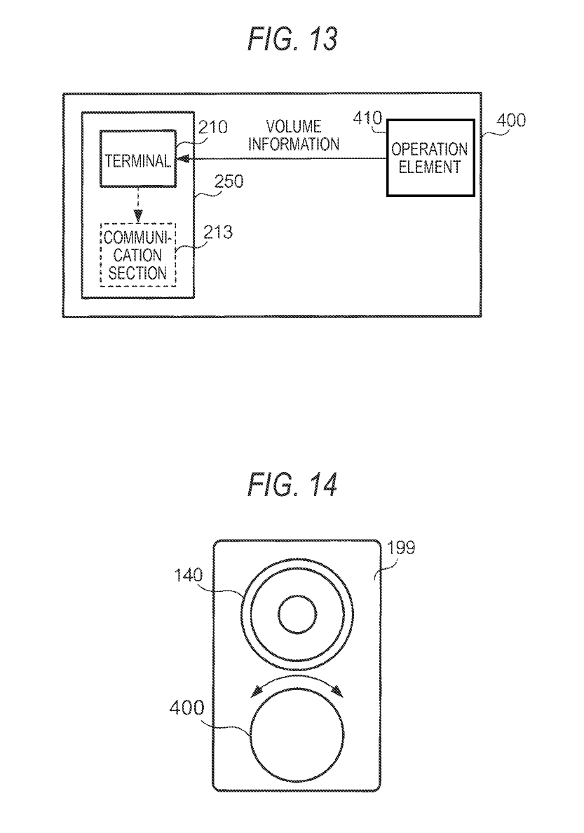

The device to be connected to the acoustic device 100 may be a device that supplies control signals for the acoustic device 100. FIG. 13 is a view illustrating the function of the operation knob 400 serving as another example of the external unit. The operation knob 400 includes an operation element 410 and the connection section 250. The operation element 410 has a rotation mechanism, a resistor circuit reflecting the operation state of the rotation mechanism and other circuits and is a rotary input switch to be operated by the user. The operation element 410 outputs a signal corresponding to the amount of the rotation as control information. This control information is supplied from the connection section 250 to the control section 170 via the terminal 210. The control section 170 controls the amplification section 151 on the basis of the received control information.

Each of all the external units has a shape provided with a terminal having a shape corresponding to the shape of the terminal 120, a main body section having a shape matching with the shape of the guide 121, and the screw 211 having a shape corresponding to the shape of the nut cover 122, whereby the mechanical connection to the acoustic device 100 is ensured. Furthermore, since the connection section 250 is provided for all the external units, the function for supplying information according to which each of the external units is identified by the acoustic device 100 is achieved.

FIG. 14 is an external view illustrating the acoustic device 100 on which the operation element 410 is mounted. The user designates the volume level of the sound to be emitted from the loudspeaker unit by rotating the operation knob 400 clockwise or counter-clockwise. With this type of operation device mounted, an acoustic parameter relating to the sound emission at the loudspeaker unit can be changed easily.

In addition, the value to be designated by the knob is not limited to the level of the volume, but may be any parameters relating to acoustic reproduction, such as the type, amount and mixture ratio of effect.

Furthermore, a button or a switch may also be provided as an operation mechanism. Moreover, this type of input mechanism may be provided in plural numbers to designate a plurality of parameters. What's more, the operation knob 400 may be provided with a liquid crystal display or the like for the confirmation of preset parameter values. Still further, the operation knob 400 may also be provided with a terminal for connection to an electronic musical instrument.

The structures of the connection sections 110 and 250 are not limited to the specific examples illustrated in FIG. 9. In short, the external unit may merely be equipped with a mechanism being configured such that the external unit can be mechanically connected to the acoustic device 100 and that the acoustic device 100 can detect the state of the connection and can specify at least the device having the connection section 250. For example, instead of making a judgment on the basis of analog data, i.e., potential, digital data may be acquired. In this case, for example, the presence/absence of the connection of the corresponding terminal on the side of the connection section 250 at each port is output using one bit, 0 or 1, and the state of the connection is indicated on the basis of totally m bits of information obtained from all the ports.

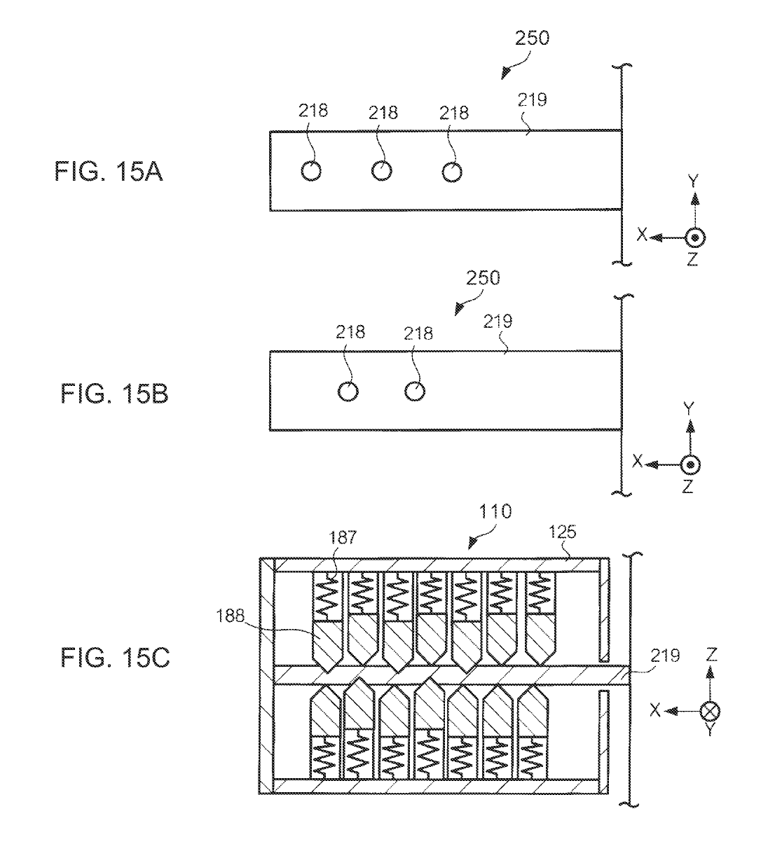

Furthermore, a shape other than a connector shape may also be adopted as the physical shape of the connection section. For example, as illustrated in FIG. 15, a plate-shaped member 219 is provided on the side of the connection section 250, and a member 125 into which the member 219 is inserted is provided on the side of the connection section 110. The relationship between the member 219 and the member 125 is, as it were, the relationship between a key and a lock. The member 219 is provided with a plurality of concave portions (dimples) 218, and the concave portions 218 are provided with a plurality of tumbler pins 188. The way in which the concave portions 218 are provided is made different for each external unit.

When the member 219 is inserted into the member 125 in the X direction, the Z direction movement distance of the tumbler pin 188 corresponding to the concave portion 218 is different from that of the tumbler pin 188 located at a position in which the concave portion 218 is not provided. The tumbler pin 188 is provided with a spring 187 and a switch (not illustrated), and the switch is turned ON/OFF depending on the movement amount of the corresponding tumbler pin 188. In this way, the external unit is identified by discriminating the pattern of the concave portions being different for each external unit. The pattern of the concave portions may further represent functional characteristics.

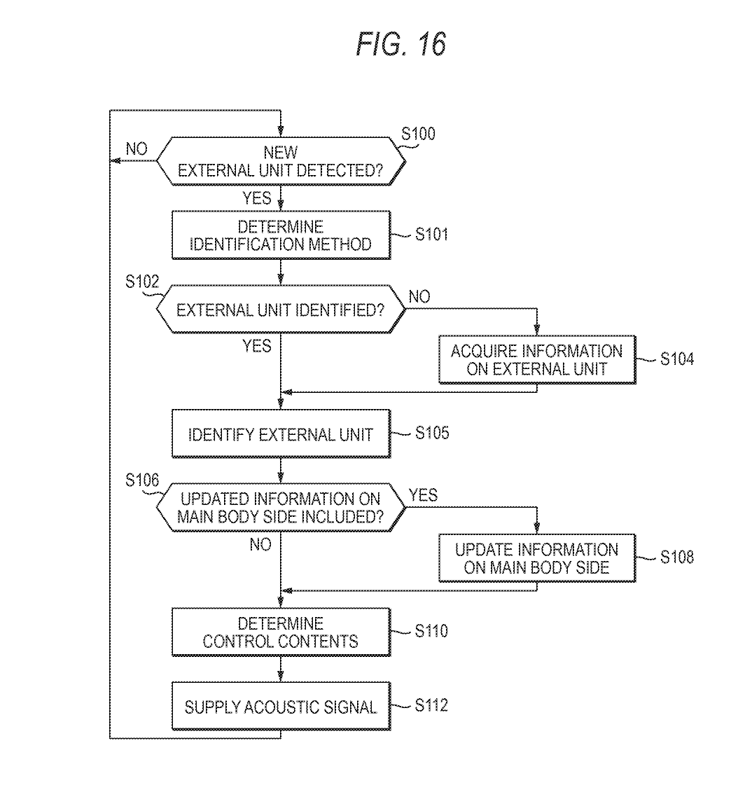

An operation example of the control section 170 will be described below in detail using FIG. 16. The connection section 110 always monitors the change in the state of the connection of the terminal 120. When the microcomputer 112 detects the change in the state of the connection (in other words, the connection of a new external unit or the disconnection of the existing external unit) of the terminal 120 (Y at S100), the control section 170 specifies one of a plurality of identification methods according to a predetermined algorithm on the basis of the detected connection state (at S101). More specifically, the control section 170 determines to use one of the following methods: method (a) in which the discrimination is made on the basis of the connection state of the terminal, method (b) in which the identification code is received and the discrimination is made, or method (c) in which the discrimination is made on the basis of the combination of the connection state of the terminal and the identification code. For example, in the case that the connection at a specific port is detected, the above-mentioned discrimination method (b) is adopted.

The control section 170 specifies a device referring to the device is information database DB1 on the basis of the information supplied from the microcomputer 112 (at S102). In the case that no device can be identified by the reference at this time, in other words, in the case that the identification code corresponding to the detected potential or the received identification code has not been registered in the device information database DB1, the control section 170 tries to acquire the information on the external unit (at S104). More specifically, the control section 170 accesses a server controlling the information on the external unit via the characteristic acquisition section 180 and acquires detailed information (unit type, input/output information and functional characteristics) on the acquired identification code and the external unit identified by the identification code. In the case that the information on the identification code cannot be acquired by performing this process, the control section 170 performs a predetermined exceptional process (for example, the control section 170 assumes that nothing is connected and writes this information in the control information table DB2). However, in the case that the control section 170 has acquired, as functional characteristics, information other than the information stored in the control information table DB2, the contents of the functional characteristics of the control information table DB2 may be updated with the acquired information.

When the external unit is identified (at 3105), the control section 170 judges whether information on the control of the acoustic device 100 is included in the information acquired from the external unit by the acoustic device 100 (at 3106). In the case that the information on the control of the acoustic device 100 is included (Y at S106) the control section 170 rewrites the items relating to the loudspeaker unit 140 in the device information database DB1 with the acquired information

After the control contents updated as described above are written in the control information table DB2 (at S110), when the control section 170 acquires an acoustic signal from the musical sound input section 160, the control section 170 supplies the acoustic signal and control signals as necessary to the acoustic signal processing section 150 and the amplification section 151 and to the external unit as necessary according to the contents of the control information table DB2 (at 3112).

In this way, the connection or disconnection of the external unit is reflected to the contents of the sound emitted from the loudspeaker unit 140. Furthermore, the loudspeaker unit 200 and the loudspeaker unit 140 are controlled interlockingly in consideration of the functional characteristics thereof. More specifically, in the case that the external unit is the loudspeaker unit 200, the sound pressure level and the frequency characteristics are adjusted in consideration of the functional characteristics of the loudspeaker unit 140 and the loudspeaker unit 200, whereby it is possible to achieve reproduced sound quality in which the characteristics of the connected loudspeaker unit 200 are utilized to the maximum extent. Since each time the connection is changed, the change is automatically reflected to the control contents, whereby it is not necessary to set acoustic characteristics, for example, each time the user mounts the external unit. With a configuration in which the contents of the control information table DB2 can be changed by the user and the user registers desired settings beforehand, a musical sound having user's favorite sound quality can be provided within the range of the function possessed by the unit even if the external unit is switched.

Furthermore, with a configuration in which firmware relating to the loudspeaker unit 140 is stored in an external unit (for example, the loudspeaker unit 200), when the external unit is connected to the acoustic device 100, the firmware relating to the loudspeaker unit 140 may be updated with the firmware stored in the external unit. With this configuration, even in the case that the external unit and the loudspeaker unit 140 cannot be controlled interlockingly in a state in which the firmware relating to the loudspeaker unit 140 has not been updated, the external unit and the loudspeaker unit 140 can be controlled interlockingly by storing an optimal firmware relating to the loudspeaker unit 140 in the external unit and by updating the firmware relating to the loudspeaker unit 140 with the optimal firmware.

Moreover, since the acoustic device 100 is provided with a plurality of identification methods and a plurality of routes through which the functional characteristics are acquired from the external unit to the acoustic device 100, the acoustic device 100 can be applied to various configurations (for example, a hardware configuration in which a large amount of information can be provided to the acoustic device 100 using the communication section and a hardware configuration in which no communication section is provided and information is supplied only via a terminal) of the external unit.

Since a judgment as to whether power is supplied to the external unit is made according to the determination based on the connection state of the terminal or according to the received identification code, even an external unit having no power source can be operated by connecting the external unit to the acoustic device 100.

With respect to the reproduction of a musical sound, in the case that an acoustic device (hereafter referred to as a non-connected cooperative device) other than the external unit is operating in cooperation with the acoustic device 100, the control contents of at least either the acoustic device 100 or the external unit may be determined in consideration of the operation contents of the non-connected cooperative device when the external unit is connected.

For example, a situation is conceived in which the non-connected cooperative device is a sub-woofer and a musical sound is wirelessly transmitted from a music reproduction device, such as a digital audio player, to both the sub-woofer and the acoustic device 100. At this time, it is assumed that the musical sound is generated so that the qualities of the sounds simultaneously emitted from both are optimized in consideration of the characteristics of the acoustic device 100 and the sub-woofer. In this case, if the loudspeaker unit 200 is newly connected as an external unit, the contents of the control information table DB2 are rewritten in consideration of the characteristics of the loudspeaker unit 200, and control is performed so that the qualities of the sounds emitted from the acoustic device 100 and the loudspeaker unit 200 are optimized as described above. However, this change of the control contents may break down the balance with the musical sound emitted from the sub-woofer, and the performance of the entire acoustic system formed of the acoustic device 100, the sub-woofer and the external unit may not be optimized.

In a preferred embodiment, in order to prevent the above-mentioned situation, upon detecting the connection of an external unit, the control section 170 judges whether a non-connected cooperative device is existent and specifies the device (in this case, the music reproduction device) controlling the non-connected cooperative device. The control section 170 then sends an inquiry signal to the music reproduction device via the characteristic acquisition section 180 and finds that the non-connected cooperative device is a sub-woofer and acquires the characteristics of the non-connected cooperative device from the music reproduction device. The control section 170 rewrites the information stored in the device control table on the basis of the information acquired from the non-connected cooperative device. For example, the control section 170 rewrites the contents of the information with the contents of information stating that musical sound signal components having frequencies not more than a predetermined frequency are cut from the musical sound is signals to be supplied to the acoustic device 100 and the loudspeaker unit 200. As a result, the musical sound signal components having frequencies lower than the predetermined frequency are emitted from only the sub-woofer, whereby the performance of the entire acoustic system is automatically optimized without requiring the user to change the settings.

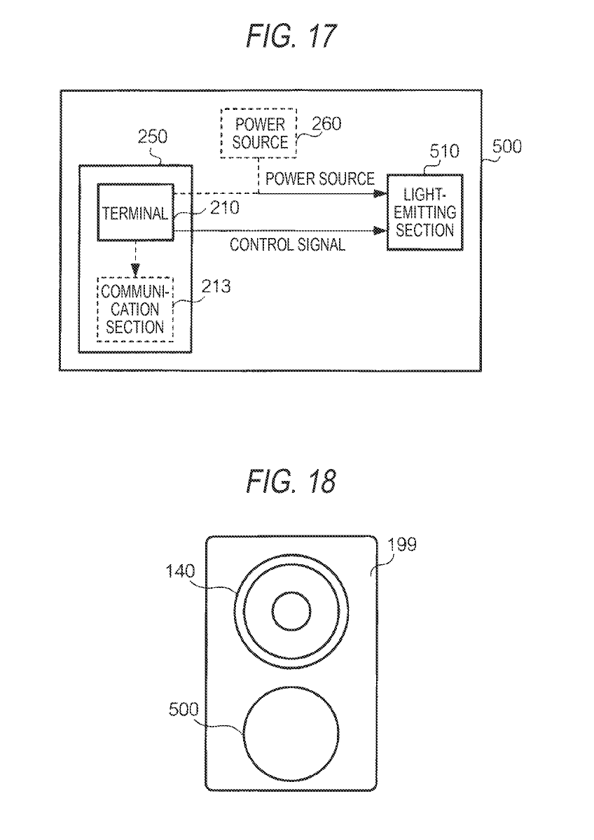

A device not directly relating to acoustic reproduction and control may also be connected as an external unit. FIG. 17 shows the function of an LED light 500 serving as an external unit. This external unit is common to the above-mentioned external unit in that the external unit has the connection section 250 and also has the power source 260 (but not essential). On the other hand, this external unit is peculiar in having a light-emitting section 510. The light-emitting section 510 has one or more LED bulbs and, in a preferred embodiment, performs light-emitting operation on the basis of the control signals supplied from the acoustic device 100 via the terminal 210. In this case, the control signals include information on light-emitting timing and light quantity (brightness) as the contents of the light-emitting operation. FIG. 18 is a view illustrating an external appearance of the acoustic device 100 to which the LED light 500 is connected.

With respect to the control signals, the control section 170 may reflect the contents (volume, frequency characteristics, tempo, and other information relating to music) of the musical sound to be emitted by the loudspeaker unit 140 to the control signals. For example, the control section 170 changes the display modes (color designation, change in color, character size, etc.) of the LED light 500 on the basis of the information on the volume, music genre, tempo, etc. of the sound emitted from the loudspeaker unit 140. In the interlocking of the musical sound and the lighting control, it is conceived that the lighting state changing in accordance with the musical sound to be reproduced gives delight.

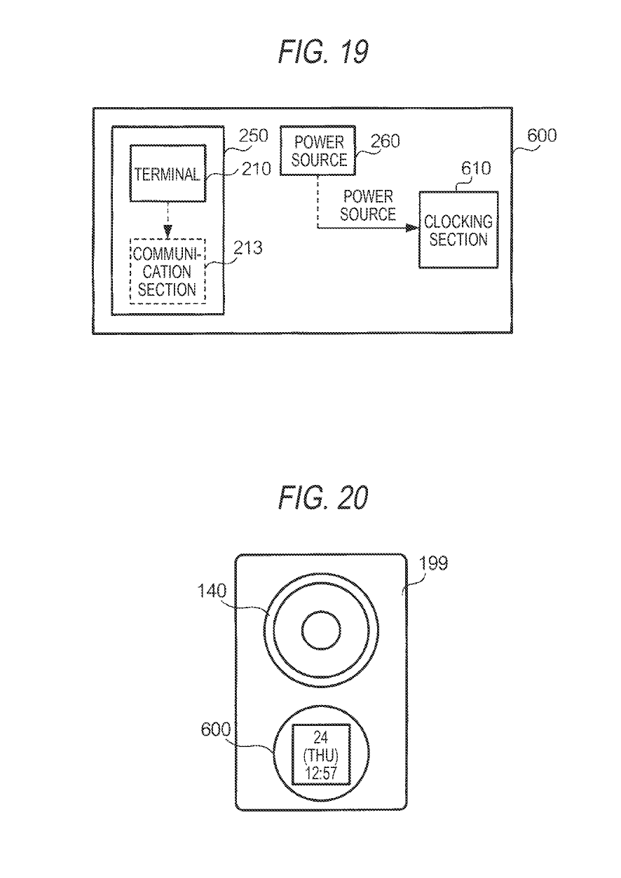

FIG. 19 shows the function of an alarm function clock 600 serving as an external unit. The alarm function clock 600 is composed of the connection section 250, the power source 260 and a clocking section 610. The clocking section 610 includes a clocking mechanism formed of a crystal oscillator or the like; an alarm mechanism formed of a ringing section, an operation element through which alarm information is input, a memory for storing alarm settings, etc.; and a liquid crystal display section for displaying operation element time and alarm setting information (these are not illustrated).

FIG. 20 is a view illustrating an example of an external appearance of the acoustic device 100 to which the alarm function clock 600 is connected. As illustrated in FIG. 19, the operation of the clock has no relation to the control of the acoustic device 100. Alternatively, like the LED light 500, the clocking section 610 may be operated on the basis of the control signals received via the connection section 250. Conversely, the loudspeaker unit 140 may be controlled on the basis of the alarm settings. For example, when an alarm setting time is reached, a volume level lowering instruction for the control section 170 is generated in the clocking section 610 and supplied to the control section 170 via the connection sections 110 and 250.

In the case that the storage contents of the device information database DB1 and the control information table DB2 have been set as described above, the control for the acoustic device 100 interlocking with the operation of the external unit connected thereto, the control for the external unit interlocking with the operation of the acoustic device 100 and the simultaneous parallel control for the acoustic device 100 and the unit can be set to desired contents.

In addition, a housing, not illustrated, having only an enclosure function exhibiting a predetermined acoustic effect may also be connected as an external unit.

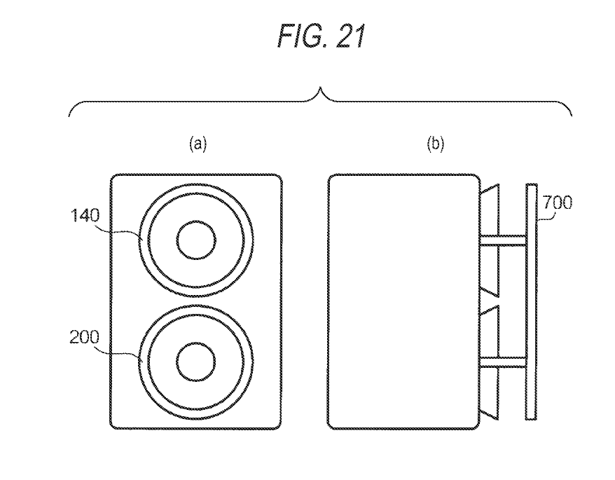

The number of external units to be connected to the acoustic device 100 is not limited to one, but a plurality of devices or an electronic component assembly may also be connected. For example, as illustrated in FIG. 21, while the loudspeaker unit 200 is mounted on the connection section 110, a diffuser 700 having a function of diffusing an acoustic wave may further be mounted as an expansion component common to the loudspeaker units 140 and 200.

Two or more connection sections 110 may also be provided for the housing 199. In other words, a plurality of external units may be mounted on the acoustic device 100 simultaneously. This configuration can increase the variation of the external appearance and the control contents of the acoustic device 100. In this case, the control section 170 identifies all the connected external units by acquiring identification codes from the terminals 120 provided for the respective connection sections 110. The acoustic signal processing section 150 and the amplification section 151 are controlled according to the function of at least one or more external units. In addition, in the acoustic device 100, it may be possible that while a combination of external units has been registered beforehand, only in the case that the combination of the connected plurality of external units matches with the registered combination, control is achieved, and that the contents of this control are registered in the control information table DB2. With this configuration, the user can enjoy the combination of external units.

The control section 170 may transmit the information stored in the control information table DB2 to other terminals. In this case, it is possible to disclose, to a third party, what type of an external unit the user connects to the acoustic device 100 and what kind of control the user performs (or performed in the past). Furthermore, this kind of disclosure information may be collected at one server so that the control contents of other users can be read. With this configuration, the user can enjoy customizing his acoustic device 100 by referring to the customized examples of the other users.

Another acoustic device 100 may also be connected as an external unit. In other words, two acoustic devices 100 may be connected to each other. More specifically, each acoustic device 100 is provided with a terminal is (hereafter referred to as a dedicated terminal) dedicated for connection to the other acoustic device 100, and in the case that the “dedicated terminal” of a first acoustic device 100 is connected to the connection section 110 of a second acoustic device 100, the functional characteristics of the two acoustic devices 100 are exchanged. Then, the first acoustic device 100 determines control contents so that the two acoustic devices function as a single acoustic device as a whole. Furthermore, three or more acoustic devices 100 having the above-mentioned configuration may also be connected.

The methods of how the functions of the connection section 110, the acoustic signal processing section 150 and the control section 170 are implemented in hardware are not limited to the examples described in the above-mentioned embodiments. Hardware, such as a processor, may be provided for each function, or a plurality of functions may be performed using a single processor. For example, the above-mentioned functions can be achieved by using a method in which a processor provided for the acoustic device 100 reads a control program from the storage section 130 and executes the program. This program can be provided in a state of being recorded on magnetic recording media (magnetic tapes, magnetic disks, etc.), optical recording media (optical disks, etc.), magneto-optical recording media, semiconductor memory devices, etc. so as to be readable by computers. Furthermore, the program can be downloaded to the acoustic device 100 via a network, such as the Internet.

In short, the acoustic device according to this disclosure may merely be equipped with a housing; a loudspeaker; a terminal provided for the housing; an identifying section for identifying an external unit mounted on the terminal; and a control section for determining control contents corresponding to the external unit identified by the identifying section and for controlling the loudspeaker according to the determined control contents.

The outline of this disclosure will be described below.

(1) This disclosure provides an acoustic device including a housing; a loudspeaker; a terminal provided on the housing; a identifying section that specifies an external unit mounted on the terminal; and a control section that determines a control content corresponding to the external unit identified by the identifying section and controls the loudspeaker according to the determined control content.

(2) For example, the control section supplies a signal corresponding to a musical sound to be reproduced by the loudspeaker to the external unit via the terminal.

(3) For example, in a case that the external unit is an external loudspeaker, the identifying section further specifies the characteristics of the external loudspeaker, and the control section supplies an acoustic signal corresponding to the characteristics of the external loudspeaker to each of the loudspeaker and the external loudspeaker.

(4) For example, the acoustic device further includes a signal is processing section that processes a sound pressure level of the acoustic signal depending on the sound pressure characteristics of the loudspeaker and the external loudspeaker respectively.

(5) For example, the acoustic device is further equipped with a signal processing section for processing the frequency characteristics of the acoustic signal on the basis of the frequency characteristics of the loudspeaker and the external loudspeaker respectively.

(6) For example, when identifying the external unit, the identifying section selects, depending on whether a change of an electrical signal due to a contact of the terminal satisfies a predetermined condition, at least either a first determination process in which the control content is determined on the basis of the change of the electrical signal or a second determination process in which the control content is determined by a reception of an identifier from the external unit.

(7) The external unit has a connection section having a flat plate shape and provided with one or a plurality of concave portions, the terminal includes a detection section that detects a position of the concave portion of the connection section when the external unit is mounted on the terminal, and the identifying section specifies the external unit on the basis of the position of the concave portion.

(8) For example, the terminal includes a frame body and a plurality of tumblers provided inside the frame body, the connection section of the external unit includes a flat plate member that can be fitted into the frame body and is provided with the one or the plurality of concave portions, and the identifying section specifies the external unit on the basis of a change of at least one of the plurality of tumblers caused at the one or the plurality of concave portions when the flat plate member is fitted into the frame body.

(9) For example, the acoustic device further includes an acquisition section that acquires the characteristics of the external unit from an external device other than the external unit.

(10) For example, the characteristics of the loudspeaker are provided from the external unit via the terminal.

(11) Furthermore, this disclosure provides an acoustic processing method including:

a step of detecting whether an external unit is mounted on a terminal provided in a housing of an acoustic device;

a step of identifying the external unit mounted on the terminal; and a step of determining a control content corresponding to the identified external unit and controlling the loudspeaker provided in the housing according to the determined control contents.

Although the present invention has been described in detail referring to the specific embodiments, it is obvious to those skilled in the art that the present invention can be changed and modified variously without departing from the spirit and scope of the present invention.

This invention is based on Japanese Patent Application (JP-2012-246224) filed on Nov. 8, 2012, the entire contents of which are hereby incorporated by reference.

### INDUSTRIAL APPLICABILITY

With the acoustic device according to this disclosure, the connection and disconnection of an external unit can be reflected to the control for the internal function thereof, whereby the connected external unit and the internal function can be controlled integrally.

### DESCRIPTION OF REFERENCE NUMERALS AND SIGNS

100 . . . acoustic device, 100, 250 connection section, 111 port, 112 . . . microcomputer, 120, 210 . . . terminal, 121 . . . guide, 122 . . . nut cover, 130 . . . storage section, 140 . . . loudspeaker unit, 150 . . . signal processing section, 151 . . . amplification section, 160 . . . musical sound input section, 170 . . . control section, 180 . . . characteristic acquisition section, 197 . . . switch, 198, 260 . . . power source, 199 . . . housing, 200 . . . loudspeaker unit (external unit), 211 . . . screw, 212 . . . main body section, 213 . . . communication section, 300 . . . display unit (external unit), 400 . . . operation knob (external unit), 500 . . . LED light (external unit), 600 . . . alarm function clock (external unit), 700 . . . diffuser (external unit

1. An acoustic device comprising:
a housing;
a loudspeaker;
a terminal provided on the housing;
an identifying section that identities an external unit mounted on the terminal; and
a control section that determines a control content corresponding to the external nit identified by the identifying section and controls the loudspeaker according to the determined control content.

2. The acoustic device according to claim 1, wherein rein the control section supplies a signal corresponding to a musical sound to be reproduced by the loudspeaker to the external unit via the terminal.

3. The acoustic device according to claim 2, wherein in a case that the external unit is an external loudspeaker, the identifying section further specifies the characteristics of the external loudspeaker; and
wherein the control section supplies an acoustic signal corresponding to the characteristics of the external loudspeaker to each of the loudspeaker and the external loudspeaker.

4. The acoustic device according to claim 3, further comprising:
a signal processing section that processes a sound pressure level of the acoustic signal depending on the sound pressure characteristics of the loudspeakers.

5. The acoustic device according to claim 3, further comprising:
a signal processing section that processes the frequency characteristics of the acoustic signal on the basis of the frequency characteristics of the respective loudspeakers.

6. The acoustic device according to claim 1, wherein when identifying the external unit, the identifying section selects, depending on whether the change of an electrical signal due to the co act of the terminal satisfies a predetermined condition, at least either a first determination method in which the control contents are determined on the basis of the change of the electrical signal or a second determination method in which the control contents are determined by the reception of an identifier from the external unit.

7. The acoustic device according to claim 1, wherein the external unit has a connection section having a flat plate shape and provided with one or a plurality of concave portions;
wherein the terminal includes a detection section that detects a position of the concave portion of the connection section when the external unit is mounted on the terminal; and
wherein the identifying section specifies the external unit on the basis of the position of the concave portion.

8. The acoustic device according to claim 6, wherein the terminal includes a frame body and a plurality of tumblers provided inside the frame body;
wherein the connection section of the external unit includes a flat plate member that can be fitted into the frame body and is provided with the one or the plurality of concave portions; and
wherein the identifying section specifies the external unit on the basis of a change of at least one of the plurality of tumblers caused at the one or the plurality of concave portions when the flat plate member is fitted into the frame body.

9. The acoustic device according to claim 1, further comprising:
an acquisition section that acquires the characteristics of the external unit from an external device other than the external unit.

10. The acoustic device according to claim 1, wherein the characteristics of the loudspeaker are provided from the external unit via the terminal.

11. An acoustic processing method comprising:
a step of detecting whether an external unit is mounted on a terminal provided in a housing of an acoustic device;
a step of identifying the external unit mounted on the terminal; and
a step of determining a control content corresponding to the identified external unit and controlling the loudspeaker provided in the housing according to the determined control content.

12. An acoustic device comprising:
a housing;
a built-in loudspeaker built in the housing;
a terminal provided on the housing;
an identifying section that identifies an external loudspeaker mounted on the terminal; and
a control section that changes a setting of a frequency characteristics of the built-in loudspeaker based on a frequency characteristics of the external loudspeaker identified by the identifying section.
